(19) United States
(12) Patent Application Publication
(10) Pub. No.: US 2020/0097997 A1
(43) Pub. Date: Mar. 26, 2020

(54) PREDICTING COUNTERFACTUALS BY UTILIZING BALANCED NONLINEAR REPRESENTATIONS FOR MATCHING MODELS

(71) Applicant: Adobe Inc., San Jose, CA (US)

(72) Inventor: Sheng Li, San Jose, CA (US)

(21) Appl. No.: 16/138,403

(22) Filed: Sep. 21, 2018

(51) Int. Cl. G06Q 30/02; G06F 15/18; G06F 17/16; G06K 9/62

(52) U.S. Cl. CPC G06Q 30/0242; G06F 15/18; G06K 9/6215; G06K 9/6276; G06F 17/16

(57) ABSTRACT

The present disclosure relates to systems, methods, and non-transitory computer readable media for generating counterfactuals low-dimensional balanced nonlinear representations for a matching model. For example, the disclosed systems can utilize an ordinal scatter discrepancy model and a maximum mean discrepancy model to generate low-dimensional balanced nonlinear representations of units. In addition, the disclosed systems can generate counterfactuals based on the low-dimensional balanced nonlinear representations by utilizing a matching model. Further, the disclosed systems can determine an average treatment effect on treated units based on the generated counterfactuals.

### BACKGROUND

Advancements in software and hardware platforms have led to a variety of improvements in systems for evaluating causal inference problems. To illustrate, causal inference problems can include understanding effects of a new medicine for curing a certain illness, determining impact of government programs on employment rates, or evaluating the performance of digital content distributed in digital content campaigns. To solve causal inference problems, conventional systems generally employ either experimental study or observational study. For the most part, experimental study is too time-consuming and resource-intensive to be practical for many applications. In recent years, observational study (i.e., extracting causal knowledge from observed data) has become more popular for solving causal inference problems.

For example, digital content campaign systems are now able to monitor and analyze digital content distributed to remote client devices as part of a digital content campaign using observational study techniques. To determine performance, digital content campaign systems can perform a process called A/B testing to, for example, provide a particular digital video to one group of users (i.e., a treatment group) and refrain from providing the digital video (or providing a different digital video) to a different group of users (i.e., a control group). However, by employing A/B testing (or similar techniques), these conventional systems suffer from a number of issues. For example, employing A/B testing can be computationally expensive and time-consuming and may lead to other risks in using real online traffic. Additionally, many conventional systems employ systematical strategies to assign users to control groups or treated groups (as opposed to random assignment) and therefore inherently suffer from a missing data problem—each user is either treated or not treated, and it is therefore impossible to observe outcomes for a user with respect to both treated and untreated scenarios. Amid efforts to overcome this problem, conventional causal inference systems have been developed to analyze observed behavior of each group (treated and control) to ascertain an effect that, for example, a digital video would have had on those users that never received the digital video.

Despite these advances however, conventional causal inference systems continue to suffer from a number of disadvantages, particularly in the accuracy, efficiency, and flexibility of evaluating the effectiveness of digital content distributed for a digital content campaign (or solving other causal inference problems). For example, although many conventional causal inference systems can generate causal inferences based on observed data, many of these systems require that such analysis occur in high-dimensional space. Due to the high-dimensionality of these problems, these systems are inefficient by requiring more computer resources, processing time, and/or power to generate predictions based on high-dimensional vectors that include large amounts of data to process and store.

In addition, conventional causal inference systems are also inaccurate. Indeed, many conventional causal inference systems evaluate performance of distributed digital content irrespective of particular covariates shared between users. As a result of generating predictions in cases where there is little covariate (e.g., attribute) overlap between treated and control groups, these conventional systems can often generate results that are neither informative nor actionable.

Moreover, some conventional causal inference systems are inflexible. For example, some conventional causal inference systems work well for a moderate number of covariates (e.g., attributes or observed behaviors) associated with each user but may fail for data with a large number of covariates due to the fact that evaluating treatment effect estimation increases with the dimensionality of covariates. As a result, many conventional systems are tailored for specific causal inference problems and may not be effective for use in other problems where dimensionality of covariate vectors may vary.

Thus, there are several disadvantages with regard to conventional causal inference systems.

### SUMMARY

One or more embodiments described herein provide benefits and solve one or more of the foregoing or other problems in the art with systems, methods, and non-transitory computer readable media that generate balanced nonlinear representations of units (e.g., users) to utilize together with a matching model to generate counterfactuals for determining the average treatment effect on treated units. In particular, the disclosed systems can utilize machine learning models to match control units with treated units based on similarities. To generate accurate matches (and accurate counterfactuals in turn), the disclosed systems utilize ordinal scatter discrepancy and maximum mean discrepancy to generate a transformation matrix for producing balanced nonlinear low-dimensional representations of units. Based on the balanced nonlinear low-dimensional representations of the units, the systems can perform a matching technique to match treated units with control units. Based on matching units, the disclosed systems can predict counterfactuals for generating an average treatment effect on treated units.

For example, the disclosed systems can determine high-dimensional representations (e.g., feature vectors) of units, where a high-dimensional representation includes covariates associated with a given unit. The systems can also convert a plurality of possible outcomes associated with the units into a set of ordinal labels (e.g., by discretizing a vector of the outcomes). In addition, the disclosed systems can utilize an ordinal scatter discrepancy model to extract low-dimensional nonlinear representations of the units. The disclosed systems can further utilize a maximum mean discrepancy model in relation to the extracted low-dimensional nonlinear representations to generate low-dimensional balanced nonlinear representations of the units. Furthermore, the systems can utilize a matching model in relation to the low-dimensional balanced nonlinear representations to generate predicted counterfactuals for the units. Based on the predicted counterfactuals, the systems can also generate an average treatment effect on treated units.

Additional features and advantages of the present application will be set forth in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment for implementing a counterfactual generation system in accordance with one or more embodiments;

FIG. 2 illustrates inputs, outputs, and components utilized by the counterfactual generation system in accordance with one or more embodiments;

FIG. 3 illustrates an example projection of unit representations into low-dimensional space in accordance with one or more embodiments;

FIG. 4 illustrates an example maximum mean discrepancy determination between unit distributions in accordance with one or more embodiments;

FIG. 5 illustrates an identified nearest neighbor matched control unit for a treated unit in accordance with one or more embodiments;

FIG. 6 illustrates an example process for training a nonlinear classification model in accordance with one or more embodiments;

FIG. 7 illustrates benefits of the disclosed counterfactual generation system relating to accuracy in accordance with one or more embodiments;

FIG. 8 illustrates benefits of the disclosed counterfactual generation system relating to accuracy in accordance with one or more embodiments;

FIG. 9 illustrates a schematic diagram of a counterfactual generation system in accordance with one or more embodiments;

FIG. 10 illustrates a flowchart of a series of acts for generating counterfactuals in accordance with one or more embodiments;

FIG. 11 illustrates a series of acts in a step for determining an average treatment effect on treated units by utilizing a balanced nonlinear representation nearest neighbor matching algorithm in accordance with one or more embodiments; and

FIG. 12 illustrates a block diagram of an example computing device in accordance with one or more embodiments.

### DETAILED DESCRIPTION

One or more embodiments described herein provide benefits and solve one or more of the foregoing or other problems in the art with a counterfactual generation system that utilizes machine learning models to generate balanced nonlinear representations of units (e.g., users) to utilize together with a matching model to generate counterfactuals for determining an average treatment effect on treated units. In particular, the counterfactual generation system can utilize a matching technique to generate counterfactuals based on matching control units (e.g., units for which the counterfactual generation system does not have observed data) to treated units (e.g., units for which the counterfactual generation system has observed data). For accurate matching, the counterfactual generation system can generate a transformation matrix to project high-dimensional covariate vectors of units to low-dimensional space. In particular, the counterfactual generation system can utilize ordinal scatter discrepancy and maximum mean discrepancy to generate low-dimensional balanced nonlinear representations of the units. Based on matching the units, the counterfactual generation system can further determine an average treatment effect on treated units (“ATT”) for a given causal inference problem such as evaluating the performance of digital content distributed as part of a digital content campaign.

For example, the counterfactual generation system can determine, for a plurality of units (e.g., control units and treated units), high-dimensional vector representations that include covariates associated with the plurality of units. In addition, the counterfactual generation system can convert a plurality of outcomes associated with the plurality of units into a set of ordinal labels. The counterfactual generation system can utilize an ordinal scatter discrepancy model based on the ordinal labels to extract low-dimensional nonlinear representations for the plurality of units. The counterfactual generation system can further generate, by utilizing a maximum mean discrepancy model based on the low-dimensional nonlinear representations of the units, low-dimensional balanced nonlinear representations of the plurality of units. Furthermore, the counterfactual generation system can utilize a matching model to match low-dimensional balanced nonlinear representations of treated units with those of control units to generate predicted counterfactuals (e.g., to fill in missing data for control units). Based on the predicted counterfactuals, the counterfactual generation system can further predict a result of, for example, a particular digital content campaign. Indeed, the counterfactual generation system can generate a prediction in the form of determining an average treatment effect on treated units.

As mentioned, the counterfactual generation system can determine high-dimensional vector representations for units. In particular, the counterfactual generation system can receive, determine, extract, or identify information for a plurality of users or other units. Based on the information, the counterfactual generation system can generate vectors to represent the users (or other units), each vector having a dimensionality that matches a number of covariates associated with the users. For example, in some embodiments the counterfactual generation system can generate high-dimensional vector representations of users where each vector can contain one hundred or more dimensions for covariates representing such things as user attributes (e.g., demographic attributes, personal information, geographic information, etc.), user behavior (e.g., responses to digital content), and/or treatment information (e.g., digital content to which the user has been exposed, time of exposure/treatment, place of exposure/treatment, etc.). In this way, the counterfactual generation system can represent users or other units with high-dimensional vector representations.

In addition, the counterfactual generation system can convert a plurality of outcomes associated with a plurality of units into a set of ordinal labels. For instance, the counterfactual generation system can utilize a clustering technique or a kernel density estimation technique to discretize possible outcomes into a particular number of ordinal labels. Indeed, the counterfactual generation system can convert an outcome vector that contains continuous values into a class label vector of discrete values. By converting continuous outcome information into discrete categories (i.e., the ordinal labels), the counterfactual generation system can convert the problem of predicting counterfactuals into a multi-class classification problem.

As mentioned, the counterfactual generation system can generate or learn a transformation matrix for projecting the high-dimensional vector representations into low-dimensional space for efficient, accurate counterfactual generation. Indeed, the counterfactual generation system can utilize the transformation matrix to generate low-dimensional nonlinear representations for the plurality of units. In particular, the counterfactual generation system can utilize an ordinal scatter discrepancy model in relation to the set of ordinal labels generated from the outcome vector to extract low-dimensional nonlinear representations for the plurality of units. In this way, the counterfactual generation system can reduce the dimensionality of the vector representations of the units by projecting the vectors into a lower-dimensional space.

As an additional part of generating the transformation matrix for generating counterfactuals, the counterfactual generation system can generate representations of units that are not only low-dimensional but also balanced. Indeed, the matching process would make less sense if the distributions of units (e.g., control units and treated units) have little or no overlap. Thus, the counterfactual generation system can balance the low-dimensional nonlinear representations to ensure actionable counterfactual generation where treated units and control units have at least some covariates that overlap (e.g., are the same or similar). In particular, the counterfactual generation system can utilize a maximum mean discrepancy model based on the extracted low-dimensional nonlinear representations to generate low-dimensional balanced nonlinear representations of the plurality of units.

The counterfactual generation system can further utilize a matching model in relation to the generated low-dimensional balanced nonlinear representations of the units to generate predicted counterfactuals. In some embodiments, the counterfactual generation system can utilize a nearest neighbor matching model, while in other embodiments the counterfactual generation system can utilize a weighting model and/or a subclassification model. In matching units utilizing a nearest neighbor technique, the counterfactual generation system can identify a query unit (e.g., a query treated unit) and identify a nearest control unit in the above-mentioned low-dimensional space. Thus, the counterfactual generation system can determine a control unit that is most similar to the query treated unit. Indeed, the distance between units in the low-dimensional space can signify or relate to a measure of similarity or correspondence of the vectors (e.g., based on their respective covariates). As a result, the counterfactual generation system can generate a counterfactual for the identified control unit by ascribing or associating observed data (e.g., a response to digital content) of the treated unit to the identified nearest control unit (for which such observed data may not exist).

Based on generating counterfactuals for one or more control units, the counterfactual generation system can further generate predictions for causal inference problems. For example, the counterfactual generation system can generate predictions for the performance of a digital content campaign. Indeed, the counterfactual generation system can determine an average treatment effect on treated units exposed to a particular item of digital content based on the generated counterfactuals used to fill in a dataset to predict behavior (or other responses) for a plurality of control units.

The counterfactual generation system provides several advantages over conventional systems. For example, the counterfactual generation system can improve accuracy. To illustrate, the counterfactual generation system can utilize a maximum mean discrepancy model to balance distributions of control units and treated units. In this way, the counterfactual generation system ensures overlap between the groups of units so that at least some control units share (e.g., have the same or similar) covariates with treated units. Thus, upon implementing a matching model to match control units with treated units (or vice versa), the counterfactual generation system identifies matches that are more similar, which in turn results in more accurate counterfactual generation. Indeed, due to balancing the distributions, the counterfactual generation system can identify a control unit (for which observed data is unavailable) that is similar to a treated unit (for which observed data is available) and can therefore treat the control unit as though it would share observed data (e.g., behavior in response to an item of digital content) with the similar treated unit.

The counterfactual generation system further improves efficiency and stability over conventional systems. To illustrate, the counterfactual generation system can increase the speed of producing counterfactuals over some conventional systems. By reducing the dimensionality of vector representations for units before identifying matches, the counterfactual generation system performs less complex matching operations, which results in faster counterfactual generation and requires fewer computer resources (e.g., processing power and storage). Additionally, the counterfactual generation system can improve upon the stability of conventional systems by reducing noise. Indeed, by reducing the dimensionality of covariate vectors, the counterfactual generation system can further reduce noisy data that might otherwise be included in high-dimensional vectors and which might otherwise adversely skew results in generating counterfactuals.

The counterfactual generation system also improves flexibility over conventional systems. For example, as a result of pre-processing covariate vectors to generate low-dimensional balanced nonlinear representations (by utilizing ordinal scatter discrepancy and maximum mean discrepancy models) before performing a matching operation, the counterfactual generation system is widely applicable to a variety of causal inference problems. Indeed, the counterfactual generation system can generate counterfactuals and predict results for problems such as the effects of a new medicine for curing a certain illness, determining the impact of government programs on employment rates, or evaluating the performance of digital content distributed as part of a digital content campaign, among others.

As illustrated by the foregoing discussion, the present disclosure utilizes a variety of terms to describe features and benefits of the counterfactual generation system. Additional detail is hereafter provided regarding the meaning of these terms as used in this disclosure. For example, the term “unit” refers to a data object for which the counterfactual generation system can gather information and can perform the various methods and techniques disclosed herein. A unit can include an individual such as a user, a customer, a patient, etc. A unit can also include a non-person object such as a car, a house, a type of medicine, a government program, a school district, a population, a business, or some other object for which the counterfactual generation system can gather information and generate a prediction.

As mentioned, the counterfactual generation system can analyze units as part of two distinct groups, a control group and treatment group. As used herein, a “control group” refers to a group of “control units” which has not been exposed to a particular treatment and/or for which the counterfactual generation system does not have observed data. By contrast, a “treatment group” refers to a group of “treated units” which is exposed to a particular treatment (e.g., a particular digital content item, a particular medicine, etc.). Thus, the counterfactual generation system has observed data for treated units. To illustrate by example, the counterfactual generation system can distribute a particular item of digital content (e.g., a digital video) to each unit in a treatment group and can observe a behavioral response or reaction to the digital content by, for example, detecting conversions/purchases, clicks, time spent watching, etc. The counterfactual generation system does not distribute the same item of digital content to the control group and therefore cannot gather observed data responsive to the digital content.

The counterfactual generation system can represent a unit with a vector having a particular number of dimensions corresponding to a number of covariates associated with the unit. As used herein, the term “covariate” refers to a control variable that can be observed and that can affect the outcome of an experiment or study. For example, a covariate can refer to a unit attribute (e.g., demographic attributes, personal information, geographic information, etc.), unit behavior (e.g., response to digital content), and/or treatment information (e.g., digital content to which the user has been exposed, time of treatment, place of treatment, etc.). In some embodiments, a covariate can refer to a feature associated with a unit can such as latent or hidden features (e.g., deep features) analyzed by a machine learning model (e.g., a neural network). Such features can include, for example, characteristics of a unit at different levels of abstraction generated at various layers of a neural network. Thus, in addition to visible attributes, covariates can contain nonlinear characteristics that are uninterpretable to human viewers.

As mentioned, the counterfactual generation system generates predicted counterfactuals for one or more units. As used herein, the term “counterfactual” refers to information relating to something that did not happen. More particularly, a counterfactual can refer to a most likely covariate of a given unit if a particular event that did not happen would have happened. For example, a counterfactual can refer to a most likely response of a control group user if the user had been exposed to the same digital content as the treatment group. Thus, a counterfactual can supplement or fill in incomplete information for control units based on matching those control units with treatment units according to this disclosure. In some embodiments, a counterfactual can relate to a single covariate, while in other embodiments a counterfactual can relate to multiple covariates at once.

To generate counterfactuals, the counterfactual generation system implements a multi-class classification technique. In particular, the counterfactual generation system utilizes an outcome framework to convert outcomes into a discrete number of ordinal labels. As used herein, the term “outcome” refers to a result associated with a particular causal inference problem. For example, in a scenario where the counterfactual generation system predicts results for a digital content campaign, an outcome can refer to a conversion, an impression, a click, a click-through rate, etc. Additionally, an outcome can also refer to a lack of any of the above, meaning that a particular outcome for a digital content campaign be that a user does not make a purchase or does not click on the video. The counterfactual generation system can represent each of the various outcomes with a numerical value. The counterfactual generation system can represent outcomes in an outcome vector as either continuous or discrete values.

As mentioned, the counterfactual generation system converts or categorizes outcomes into a set of ordinal labels. The term “ordinal label” refers to a class or category of results associated with a causal inference problem. As a broad example, ordinal labels for predicting results of a digital content campaign could be successful or unsuccessful (e.g., conversion or no conversion). The counterfactual generation system can represent ordinal labels as numerical values. For instance, given an outcome vector Y=[0.3, 0.5, 1.1, 1.2, 2.4], the counterfactual generation system can generate a label vector of ordinal labels Y₃=[1, 1, 2, 2, 3] where the label vector contains three categories/labels (e.g., 1, 2, and 3) and outcomes from 0 to 1 are in label 1, outcomes from 1 to 2 are in label 2, and outcomes from 2 to 3 are in label 3.

As mentioned, the counterfactual generation system can utilize a matching model to match units. As used herein, the term “matching model” can refer to a machine learning model that the counterfactual generation system uses to match treated units with control units or vice-versa. For example, a matching model can include a nearest neighbor matching model, a weighting model, or a subclassification model. “Nearest neighbor matching” can refer to pairing a given point or unit with another closest point or unit. Indeed, the counterfactual generation system can determine distances between low-dimensional balanced nonlinear representations of units to determine, for a given treated unit, a control unit with a smallest distance therefrom.

Indeed, the counterfactual generation system can generate counterfactuals by identifying matching units and classifying units into ordinal labels. For example, the counterfactual generation system can perform the processes and methods described herein by utilizing a “nonlinear classification model” to classify units into ordinal label categories. Compared to linear models, nonlinear classification models are more capable of dealing with complicated data distributions. In some embodiments, the counterfactual generation system utilizes a balanced nonlinear representation nearest neighbor matching (“BNR-NNM”) model to classify units by generating low-dimensional balanced nonlinear representations and utilizing nearest neighbor matching as disclosed herein.

In some embodiments, the counterfactual generation system trains one or more machine learning models to generate predicted counterfactuals based on training data. As used herein, the term “train” refers to utilizing information to tune or teach a neural network or other model. The term “training” (used as an adjective or descriptor, such as “training digital frames” or “training digital video”) refers to information or data utilized to tune or teach the model.

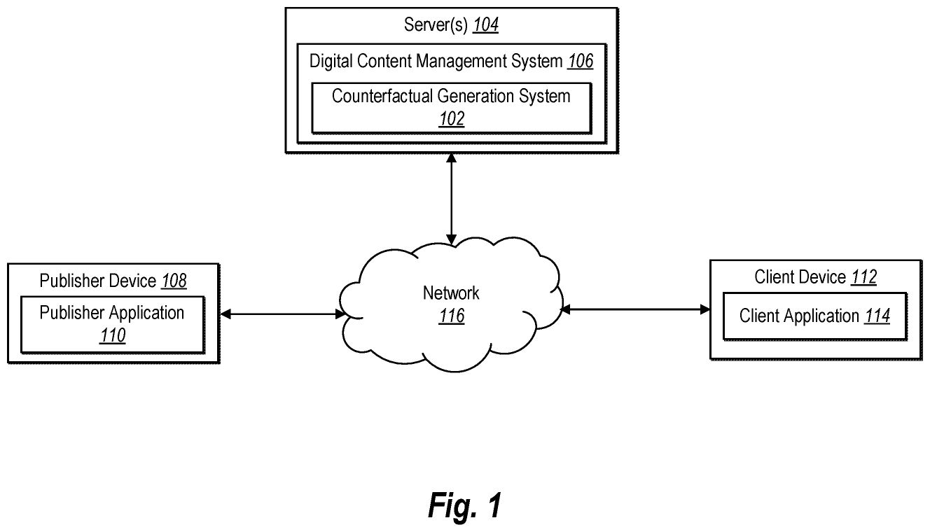

Additional detail regarding the counterfactual generation system will now be provided with reference to the figures. For example, FIG. 1 illustrates a schematic diagram of an example environment for implementing a counterfactual generation system 102 in accordance with one or more embodiments. An overview of the counterfactual generation system 102 is described in relation to FIG. 1. Thereafter, a more detailed description of the components and processes of the counterfactual generation system 102 is provided in relation to the subsequent figures.

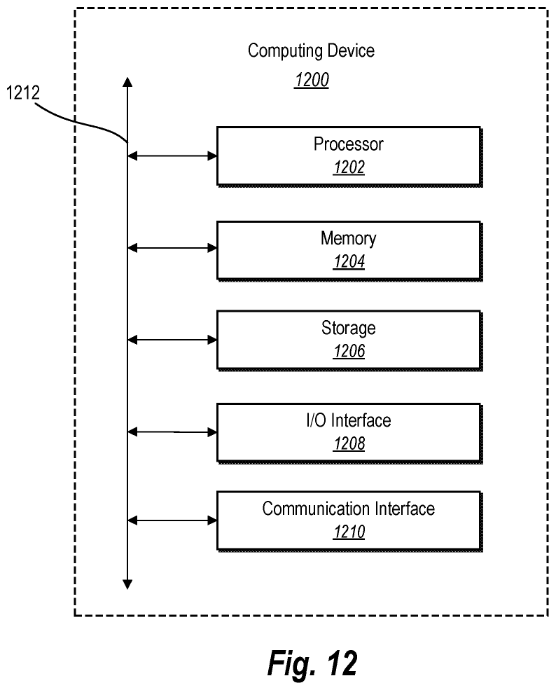

As shown in FIG. 1, the environment includes server(s) 104, a publisher device 108, a client device 112, and a network 116. Each of the components of the environment can communicate via the network 116, and the network 116 may be any suitable network over which computing devices can communicate. Example networks are discussed in more detail below in relation to FIG. 12.

As shown in FIG. 1, the environment includes a publisher device 108. The publisher device 108 can be one of a variety of computing devices, including a smartphone, tablet, smart television, desktop computer, laptop computer, virtual reality device, augmented reality device, or other computing device as described in relation to FIG. 12. The publisher device 108 can be associated with a digital content publisher, and the publisher device 108 can be capable of providing digital content and monitoring client devices associated with the digital content management system 106. For example, the digital content management system 106 can receive one or more items of digital content from the publisher device 108 to distribute as part of a digital content campaign.

Similarly, the environment includes a client device 112. The client device 112 can be one of a variety of computing devices, including a smartphone, tablet, smart television, desktop computer, laptop computer, virtual reality device, augmented reality device, or other computing device as described in relation to FIG. 12. Although FIG. 1 illustrates a single client device 112, in some embodiments the environment can include multiple different user client devices, each associated with a different user. Thus, the counterfactual generation system 102 can monitor the client devices to determine covariates for vectors associated with each respective unit.

As illustrated in FIG. 1, the environment includes the server(s) 104. The server(s) 104 may generate, store, receive, and transmit electronic data, such as digital video, digital images, digital audio, metadata, etc. For example, the server(s) 104 may receive data from the publisher device 108 in the form of a digital video. In addition, the server(s) 104 can transmit data to the client device 112 to provide the digital video. For example, the server(s) 104 can communicate with the client device 112 to transmit and/or receive data via the network 116. In some embodiments, the server(s) 104 comprises a content server. The server(s) 104 can also comprise an application server, a communication server, a web-hosting server, a social networking server, or a digital content campaign server.

As shown in FIG. 1, the server(s) 104 can also include the counterfactual generation system 102 as part of a digital content management system 106. The digital content management system 106 can communicate with the client device 112 to provide digital content such as digital video, digital images, or some other type of information. Indeed, the digital content management system 106 can refer to a digital content campaign system (e.g., a system for selecting and providing customized digital videos to client devices simultaneously accessing websites or other digital assets) and/or a system for analyzing another type of causal inference problem.

Although FIG. 1 depicts the counterfactual generation system 102 located on the server(s) 104, in some embodiments, the counterfactual generation system 102 may be implemented by (e.g., located entirely or in part) on one or more other components of the environment. For example, the counterfactual generation system 102 may be implemented by the client device 112 and/or the publisher device 108.

Moreover, in one or more embodiments, the counterfactual generation system 102 is implemented on a third-party server. For example, in such embodiments, the server(s) 104 may be associated with a digital content publisher, and a third-party server can host the counterfactual generation system 102. Specifically, the third-party server can receive information regarding a user, provide identification information for the user from the third-party server to the digital content publisher by way of the server(s) 104, and the server(s) 104 can select and provide digital content for display to a client device (e.g., the client device 112) of a user.

As shown, the publisher device 108 includes a publisher application 110. The publisher application 110 may be a web application or a native application installed on the publisher device 108 (e.g., a mobile application, a desktop application, etc.). The publisher application 110 can interface with the counterfactual generation system 102 to provide digital content as well as distribution parameters for a digital content campaign. The publisher application 110 can be configured to enable a publisher to set digital content campaign settings and to manage digital content for distribution to define a control group and a treatment group.

As illustrated in FIG. 1, the client device 112 includes a client application 114. The client application 114 may be a web application or a native application installed on the client device 112 (e.g., a mobile application, a desktop application, etc.). The client application 114 can interface with the digital content management system 106 to receive digital content such as digital video from the server(s) 104, and to present (e.g., display) the digital content received from the server(s) 104. In addition, the client application 114 can collect and provide information associated with a user to the counterfactual generation system 102. For instance, the client application 114 can provide information relating to user attributes and user behavior. Thus, the counterfactual generation system 102 can monitor responses to particular digital content items.

In some embodiments, though not illustrated in FIG. 1, the environment may have a different arrangement of components and/or may have a different number or set of components altogether. For example, the publisher device 108 and/or the client device 112 may communicate directly with the counterfactual generation system 102, bypassing the network 116. Additionally, the counterfactual generation system 102 can include one or more databases (e.g., a digital content database) housed on the server(s) 104 or elsewhere in the environment. Further, the counterfactual generation system 102 can include one or more machine learning models. The counterfactual generation system 102 can be implemented in a variety of different ways across the server(s) 104, the network 116, the publisher device 108, and the client device 112.

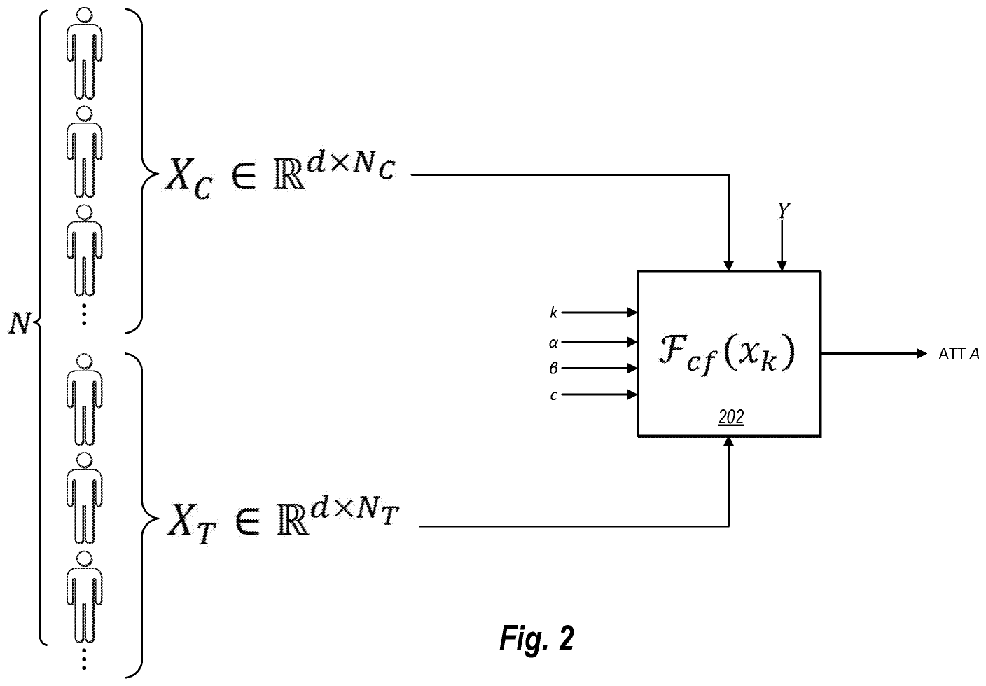

As mentioned above, the counterfactual generation system 102 can determine an average treatment effect on treated units (“ATT”) based on generating counterfactuals for one or more units. FIG. 2 illustrates a high-level view of the process of analyzing a plurality of units to determine an ATT A associated with the units. In relation to generating counterfactuals and determining ATT A, as set forth in this disclosure, the counterfactual generation system 102 can perform the various methods and functions according to the following notation: Let X=[X_{C},X_{T}] ∈ [symbol] ^{d×N} denote the covariates of all units, where X_{C} ∈ [symbol] ^{d×N}^{_{C}} is a control group with N_{C} units and X_{T} ∈ [symbol] ^{d×N}^{_{T}} is a treatment group with N_{T} units. N is the total number of units and d is the number of covariates for each unit. For further reference although not illustrated in FIG. 2, ϕ: x ∈ [symbol] ^{d}→ϕ(x) ∈ [symbol] is a nonlinear mapping function from sample space [symbol] to an implicit feature space [symbol] . In addition, T ∈ [symbol] ^{N×1} is a binary vector to indicate if the units received treatment or not, and Y ∈ [symbol] ^{N×1} is an outcome vector, where the elements in Y could be either discrete or continuous values.

As an alternative to determining the ATT, in some embodiments the counterfactual generation system 102 generates an average treatment effect on all units (“ATE”). To illustrate, the counterfactual generation system 102 determines an ATE across units in both the treated group and the control group. For example, the counterfactual generation system 102 determines an average performance of digital content distribution as part of a digital content campaign.

As shown in FIG. 2, the counterfactual generation system 102 determines or identifies N units. Considering binary treatments for the set of N units, the counterfactual generation system 102 can determine two possible outcomes for each unit. To illustrate, for a unit k, the counterfactual generation system 102 can generate an outcome Yₖ(1) if the unit received treatment or Yₖ(0) if the unit did not receive treatment. Thus, the counterfactual generation system 102 can determine an individual-level treatment effect given by:

γₖ=Yₖ(1)−Yₖ(0).

As illustrated in FIG. 2, the counterfactual generation system 102 can divide or group the N units into a control group and a treatment group. Generally, a unit can either be a control unit or a treated unit, but not both—indeed, either a user is exposed to a particular digital content item or they are not. Thus, the counterfactual generation system 102 may lack treatment response information for control units due to the fact that the control units are not treated. As part of solving this missing data problem, the counterfactual generation system 102 can utilize a potential outcome framework.

To illustrate a potential outcome framework, the counterfactual generation system 102 can utilize a stable unit treatment value assumption (“SUTVA”). For instance, the counterfactual generation system 102 can determine or require that the outcomes for units do not vary with treatments assigned to other units. In addition, the counterfactual generation system 102 can determine or require that, for each unit, there are no different forms or versions of a given treatment level, which might lead to different potential outcomes.

The counterfactual generation system 102 can further utilize a strongly ignorable treatment assignment (“SITA”). To illustrate, the counterfactual generation system 102 can determine or require that treatment for a particular unit is independent of potential outcomes, conditional on the covariates associated with the particular unit. For instance, for covariates xₖ, treatment Tₖ is independent of potential outcomes, as indicated by an unconfoundedness:

(Yₖ(1),Yₖ(0)) ⊥ Tₖ|xₖ

and an overlap:

0<Pr(Tₖ=1|xₖ)<1.

Based on the SUTVA and SITA assumptions, the counterfactual generation system 102 can model treatment of a particular unit with respect to its covariates, independent of outcomes and other units.

As an additional aspect of solving the missing data problem, the counterfactual generation system 102 can utilize a matching technique, as mentioned above. For instance, the counterfactual generation system 102 can generate a predicted counterfactual for a treated unit by seeking its most similar counterpart in the control group, thereby filling in the missing information for the similar control unit. As mentioned above, and as shown in FIG. 2, the counterfactual generation system 102 can utilize a BNR-NNM model 202 to generate predicted counterfactuals by utilizing a matching technique such as nearest neighbor matching.

Additionally, the counterfactual generation system 102 can utilize the BNR-NNM model 202 to generate or determine an average treatment effect on treated units (“ATT”), A. As illustrated in FIG. 2, to generate the ATT A, the counterfactual generation system 102 can define the covariates of a control group as:

X_{C} ∈ [symbol] ^{d×N}^{_{C}}

and the covariates of a treatment group as:

X_{T} ∈ [symbol] ^{d×N}^{_{T}}

where T is a binary vector indicating if the units received treatment (Tₖ=1 if yes, Tₖ=0 if no), Y is an outcome vector, N is the total number of units, N_{C} and N_{T} are the sizes of the control group and the treatment group, respectively.

Based on analyzing the covariates associated with the control group and the treatment group by utilizing a BNR-NNM model 202, the counterfactual generation system 102 can identify or select a nearest neighbor in the control group for a given treated unit in terms of covariates. In particular, the counterfactual generation system 102 can consider the outcome of the identified/selected control unit as a predicted counterfactual. Based on generating the predicted counterfactuals, the counterfactual generation system 102 can determine the ATT A, given by:

$$ATT A = \frac{1}{{N}_{T}} {\sum }_{k : {T}_{k} = 1} ( {Y}_{k} ( 1 ) - {\hat{Y}}_{k} ( 0 ) )$$

where Ŷₖ(0) is the counterfactual generated from k's nearest neighbor in the control group.

As mentioned, in some embodiments the counterfactual generation system 102 determines an ATE rather than an ATT. For instance, the counterfactual generation system 102 determines an average treatment effect across all units. In some embodiments, the ATE can be given by:

$$ATE A = \frac{1}{N} {\sum }_{k} ( {Y}_{k} ( 1 ) - {\hat{Y}}_{k} ( 0 ) ) .$$

The counterfactual generation system 102 can implement nearest neighbor matching in a variety of ways. In some embodiments, the counterfactual generation system 102 can utilize different distance metrics or can choose a different number of neighbors. For example, the counterfactual generation system 102 can utilize Euclidean distance or Mahalanobis distance as part of nearest neighbor matching.

The BNR-NNM model 202 can include a matching estimator that provides distinct advantages over conventional matching estimators. For example, by utilizing the BNR-NNM model 202, the counterfactual generation system 102 performs matching in an intermediate low-dimensional subspace that provides a low estimation bias, whereas many conventional estimators adopt either original covariate subspace or one-dimensional space. In addition, by utilizing the BNR-NNM model 202, the counterfactual generation system 102 considers balanced distributions across treatment and control groups, as mentioned above.

As mentioned above, the counterfactual generation system 102 converts the causal inference problem of generating counterfactuals into a multi-class classification problem. To illustrate, the counterfactual generation system 102 obtains an observed outcome Yₖ(1) and generates a counterfactual Ŷₖ(0). Indeed, the counterfactual generation system 102 trains the BNR-NNM model 202 that generates predicted counterfactuals for any units given its covariate vector xₖ. For instance, the counterfactual generation system 102 can train and utilize the BNR-NNM model 202 to predict counterfactuals given a set of X units and the corresponding outcome vector Y according to:

Ŷₖ(0)= [symbol] _{cf}(xₖ)

to thereby map from the covariate space to the outcome space.

As part of implementing a classification problem, the counterfactual generation system 102 projects from covariate space to an intermediate representation space in which closer units (e.g., units with a smaller distance between them) have a higher probability of resulting in the same or similar outcomes. As mentioned, the counterfactual generation system 102 categorizes the outcome vector Y into multiple levels or classes on the basis of the magnitude of given outcome values. Indeed, the counterfactual generation system 102 generates a set of ordinal labels from the outcome vector Y.

For example, in some embodiments the counterfactual generation system 102 utilizes a clustering technique to discretize the outcome vector Y. In particular, the counterfactual generation system 102 groups outcomes to classify each outcome into a specific class or ordinal label. The counterfactual generation system 102 can group outcomes according to different rules such as by grouping numerical values within certain ranges together. For example, given an outcome vector Y=[0.3, 0.5, 1.1, 1.2, 2.4], the counterfactual generation system 102 can generate a label vector of ordinal labels Y₃=[1, 1, 2, 2, 3] where the label vector contains three categories/labels (e.g., 1, 2, and 3). Thus, the counterfactual generation system 102 generates a label vector Y_{c} with c categories. In some embodiments, the counterfactual generation system 102 can implement a k-means clustering technique, a mean-shift clustering technique, a density-based spatial clustering technique, an expectation-maximization clustering technique, or an agglomerative hierarchical clustering technique.

In other embodiments, the counterfactual generation system 102 discretizes the outcome vector Y by utilizing a kernel density estimation technique. In particular, the counterfactual generation system 102 can utilize a non-parametric estimation of a probability density function such as the outcome vector Y. For example, the counterfactual generation system 102 can utilize kernel functions such as a normal kernel function, a triangular kernel function, or a normal kernel function with varying bandwidths and/or amplitudes to generate a discrete representation of the outcome vector Y.

As further illustrated in FIG. 2, the counterfactual generation system 102 utilizes the BNR-NNM model 202 to generate the ATT A based on the covariates X, the outcome vector Y, in addition to a kernel function k and parameters α, β, and c. For instance, α is a non-negative tradeoff parameter, β is a tradeoff parameter to balance the effects of terms of an objective function of the BNR-NNM model 202, and c is the number of ordinal labels used to categorize the outcome vector Y.

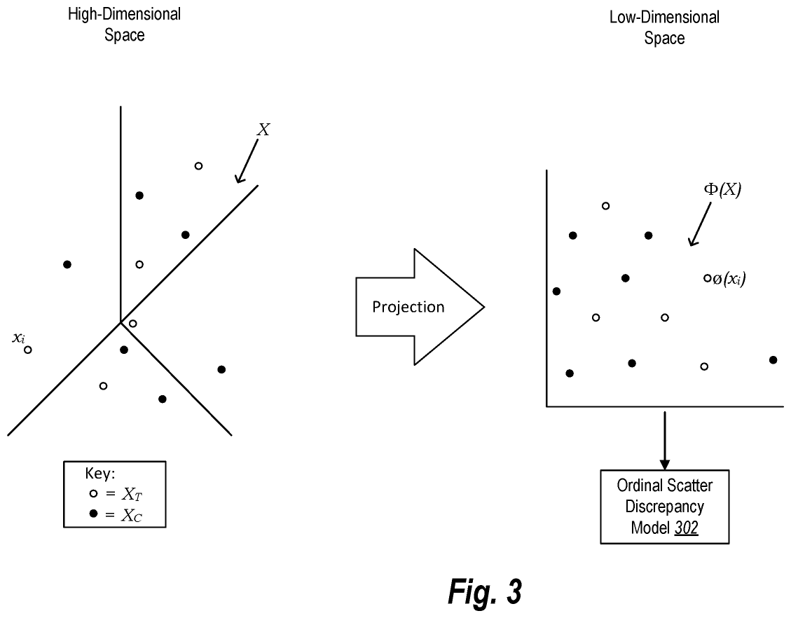

As mentioned, the counterfactual generation system 102 projects unit representations from high-dimensional covariate space to a lower-dimensional intermediate space. Indeed, FIG. 3 illustrates a graphical representation of generating low-dimensional nonlinear representations of units. For instance, as illustrated in the overly-simplified example of FIG. 3, the counterfactual generation system 102 maps units X by projecting the units into low-dimensional space to generate low-dimensional nonlinear representations Φ(X). While FIG. 3 illustrates a three-dimensional high-dimensional space mapped to a two-dimensional low-dimensional space, this is merely illustrative. The counterfactual generation system 102 can analyze covariate representations in high-dimensional space having hundreds of dimensions and generate low-dimensional nonlinear representations having different numbers of dimensions as well.

As illustrated in FIG. 3, the counterfactual generation system 102 can project a unit xᵢ to generate a low-dimensional nonlinear representation ϕ(xᵢ) of the unit. Thus, the counterfactual generation system 102 can generate low-dimensional nonlinear representations of units given by:

Φ(X)=[ϕ(x₁),ϕ(x₂), . . . ,ϕ(x_{N})].

In addition, the counterfactual generation system 102 utilizes a maximum scatter difference criterion as set forth in Qishan Liu, Xiaoou Than, Hanging Lu, Songde Ma, et al., Face Recognition Using Kernel Scatter-Difference-Based Discriminant Analysis, IEEE Transactions on Neural Networks, 17(4):1081-85 (2006), which is incorporated herein by reference in its entirety. In particular, the counterfactual generation system 102 utilizes the maximum scatter difference and the ordinal label information from discretizing the outcome vector Y to generate a criterion called ordinal scatter discrepancy.

By utilizing an ordinal scatter discrepancy model 302, the counterfactual generation system 102 generates a desired data distribution after projecting Φ(X) to a low-dimensional subspace. In particular, the counterfactual generation system 102 utilizes the ordinal scatter discrepancy to minimize within-class scatter while also maximizing a non-contiguous class scatter matrix. To illustrate, the counterfactual generation system 102 maps unit samples onto a subspace by maximizing the differences of noncontiguous-class scatter and within-class scatter. For example, the counterfactual generation system 102 utilizes the ordinal scatter discrepancy model in kernel space to learn, generate, or obtain low-dimensional nonlinear representations based on the objective function:

arg maxₚ F(P,Φ(X),Y_{c})=tr(p^{T}(K_{I}−αK_{W})P),

s.t.P^{T}P=I

where K_{I} is a noncontiguous-class scatter matrix in kernel space, K_{W} is a within-class scatter matrix in kernel space, α is a non-negative tradeoff parameter, tr(·) is the trace operator for a matrix, and I is an identity matrix. The orthogonal constraint P^{T}P=I is introduced to reduce redundant information in the projection. The detailed definitions of the noncontiguous-class scatter matrix K_{I} and the within-class scatter matrix K_{W} are:

$${K}_{I}^{Φ} = \frac{c ( c - 1 )}{2} {\sum }_{i = 1}^{c} {\sum }_{j = i + 1}^{c} {e}^{( j - 1 )} ( {m}_{i} - {m}_{j} ) {( {m}_{i} - {m}_{j} )}^{T} and$$

$${K}_{W}^{Φ} = \frac{1}{N} {\sum }_{i = 1}^{c} {\sum }_{j = 1}^{{n}_{i}} ( ξ ( {x}_{ij} ) - \overline{m} ) {( ξ ( {x}_{ij} ) - {\overline{m}}_{i} )}^{T}$$

where ξ(xᵢⱼ)=[k(x₁,xᵢⱼ), k(x₂,xᵢⱼ), . . . k(x_{N},xᵢⱼ)]^{T}, mᵢ is the mean vector of ξ(xᵢⱼ) that belongs to the i^{th} class, m̅ is the mean vector of all ξ(xᵢⱼ), and nᵢ is the number of units in the i^{th} class. In addition, k(xᵢ,xⱼ)= [symbol] ϕ(xᵢ),ϕ(xⱼ) [symbol] is a kernel function which the counterfactual generation system 102 utilizes to avoid calculating the explicit form of function ϕ, sometimes referred to as the “kernel trick.”

By utilizing the noncontiguous-class scatter matrix K_{I}, the counterfactual generation system 102 characterizes the scatter of a set of classes with ordinal labels. The counterfactual generation system 102 measures the scatter of every pair of classes. In addition, the counterfactual generation system 102 utilizes the factor e^{(j-i)} to penalize the classes that are noncontiguous. Indeed, contiguous classes may be closer together after projection, while noncontiguous classes are pushed away. Thus, the counterfactual generation system 102 uses heavier weights for or otherwise emphasizes the noncontiguous classes.

For example, the counterfactual generation system 102 can utilize weights where e⁽²⁻¹⁾<e⁽³⁻¹⁾, because, based on the above example of outcome vector Y=[0.3, 0.5, 1.1, 1.2, 2.4], the counterfactual generation system 102 can assume that Class 1 should be closer to Class 2 than Class 3. Indeed, Class 2 is closer to Class 1 than Class 3 because 0.3 and 0.5 (the outcomes in Class 1) are closer to 1.1 and 1.2 (the outcomes in Class 2) than 2.4 (the outcome in Class 3) is to 1.1 and 1.2. Thus, the counterfactual generation system 102 can intuitively weight parameters according to closeness or grouping of outcomes.

Further, the counterfactual generation system 102 can utilize the within-class scatter matrix K_{W} to measure or determine within-class scatter. In particular, the counterfactual generation system 102 can operate under the assumption that units having the same classes or ordinal labels will be close to each other in the feature space, and therefore they will have similar feature representations after projection.

By utilizing the ordinal scatter discrepancy criterion, the counterfactual generation system 102 provides advantages over conventional models that use other discriminative criteria (e.g., a Fisher criterion or a maximum scatter difference criterion). For example, the counterfactual generation system 102 learns, via the ordinal scatter discrepancy, nonlinear projection and feature representations in reproducing kernel Hilbert space (“RKHS”), which provides advantages with complicated data distributions. In addition, the counterfactual generation system 102, by using the ordinal scatter discrepancy, explicitly makes use of ordinal label information which is generally ignored by conventional systems.

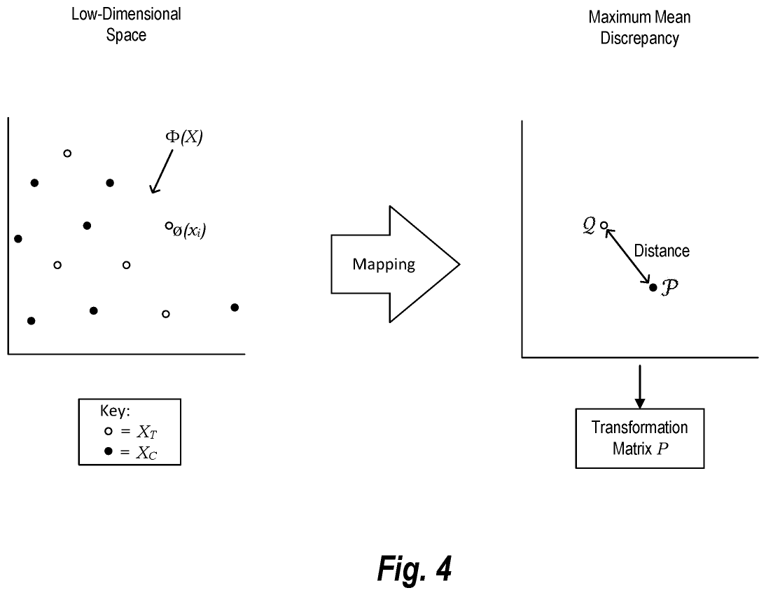

As mentioned, the counterfactual generation system 102 not only generates low-dimensional nonlinear representations of units, but further balances the generated low-dimensional nonlinear representations. Indeed, FIG. 4 illustrates generating low-dimensional balanced nonlinear representations of units by utilizing a maximum mean discrepancy model. As shown, the counterfactual generation system 102 determines a maximum mean discrepancy between control units and treated units.

To illustrate, the counterfactual generation system 102 maps the control units X_{C} and the treated units X_{T} according to their respective distributions. In some embodiments, the counterfactual generation system 102 maps the control group by averaging the values (i.e., determining the mean) of the control units. The counterfactual generation system 102 further maps the treatment group by determining the mean of the treated units. Based on the mapping of the control group and the treatment group, as shown in FIG. 4, the counterfactual generation system 102 determines a distance between the control group distribution and the treatment group distribution which indicates a maximum mean discrepancy between the groups.

More specifically, the counterfactual generation system 102 determines a distribution [symbol] for the control group X_{C} and further determines a distribution [symbol] for the treatment group X_{T}. By utilizing a maximum mean discrepancy, the counterfactual generation system 102 implies the empirical estimation of the distance between [symbol] and [symbol] . In particular, the counterfactual generation system 102 generates a distance estimate between nonlinear feature sets Φ(X_{C}) and Φ(X_{T}), given by:

$$Dist ( Φ ( {X}_{C} ) , Φ ( {X}_{T} ) ) = {‖ \frac{1}{{N}_{C}} {\sum }_{i = 1}^{{n}_{C}} φ ( {X}_{Ci} ) - \frac{1}{{N}_{T}} {\sum }_{i = 1}^{{n}_{T}} φ ( {X}_{Ti} ) ‖}_{F}^{2}$$

where [symbol] denotes a kernel space.

By utilizing the kernel trick (e.g., the kernel function k(xᵢ,xⱼ)= [symbol] ϕ(xᵢ),ϕ(xⱼ) [symbol] ), the counterfactual generation system 102 converts Dist(Φ(X_{C}),Φ(X_{T})) in the original kernel space to:

Dist(Φ(X_{C}),Φ(X_{T}))=tr(KL)

where

$$K = [ \begin{matrix}{K}_{CC} & {K}_{CT} \\ {K}_{TC} & {K}_{TT}\end{matrix} ]$$

is a kernel matrix, K_{CC}, K_{TT}, K_{CT}, and K_{TC} are kernel matrices defined on control group, treatment group, and cross groups, respectively. In addition, L is a constant matrix where, if xᵢ,xⱼ ∈ X_{C},

$${L}_{ij} = \frac{1}{{N}_{C}^{2}} ;$$

if xᵢ,xⱼ ∈ X_{T},

$${L}_{ij} = \frac{1}{{N}_{T}^{2}} ;$$

otherwise,

$${L}_{ij} = - \frac{1}{{N}_{C} {N}_{T}} .$$

Additionally, the counterfactual generation system 102 further measures the maximum mean discrepancy for low-dimensional nonlinear representations of units. Indeed, the counterfactual generation system 102 determines the maximum mean discrepancy for the new representations according to:

ψ(X_{C})=P^{T}Φ(X_{C})

and

ψ(X_{T})=P^{T}Φ(X_{T}).

Based on mapping the unit according to the transformation matrix P and utilizing the kernel trick, the counterfactual generation system 102 can determine the maximum mean discrepancy between the control group and the treatment group, given by:

Dist(ψ(X_{C}),ψ(X_{T}))=tr(P^{T}KLKP).

In some embodiments, the counterfactual generation system 102 implements the maximum mean discrepancy model set forth in Karsten M. Borgwardt, Arthur Gretton, Malte J. Rasch, Hans-Peter Kriegel, Bernhard Schölkopf, and Alex J. Smola, Integrating Structured Biological Data by Kernel Maximum Mean Discrepancy, Bioinformatics, 22(14): e49-e57 (2006), which is incorporated herein by reference in its entirety.

The counterfactual generation system 102 can perform the techniques and methods described in relation to FIGS. 3 and 4 on the same set of units, but with different partitions. For generating nonlinear representations, for example, the counterfactual generation system 102 can merge the control group and treatment group, assign an ordinal label for each unit, and then learn or determine discriminative nonlinear features accordingly. For balancing the low-dimensional nonlinear representations (to generate low-dimensional balanced nonlinear representations), the counterfactual generation system 102 can mitigate the distribution discrepancy between the control group and the treatment group. Indeed, by combining the objectives for nonlinear and balanced representations as set forth in relation to FIG. 3 and FIG. 4, respectively, the counterfactual generation system 102 can extract effective low-dimensional balanced nonlinear representations for the purpose of treatment effect estimation (e.g., determining an average treatment effect on treated units).

Indeed, utilizing the methods and techniques described herein, the counterfactual generation system 102 can generate an objective function for the BNR-NNM model 202 given by:

arg maxₚ F(P, Φ(X), Y_{c})−βDist(ψ(X_{C}), ψ(X_{T}))=tr(P^{T}(K_{I}−αK_{W})P)−βtr(P^{T}KLKP),

s.t.P^{T}P=I

where β is a tradeoff parameter to balance the effects of two terms, and a negative is used for βDist(ψ(X_{C}),ψ(X_{T})) to adapt it to the maximization problem.

The counterfactual generation system 102 can determine, learn, or generate a transformation matrix P from the above equation. Indeed, the counterfactual generation system 102 projects units into a new space by utilizing a transformation matrix P. As set forth, to generate or learn the transformation matrix P, the counterfactual generation system 102 implements one or more of the techniques or methods described in relation to FIGS. 3 and 4. In some embodiments, the counterfactual generation system 102 can learn different variations of the transformation matrix P. For example, different causal inference problems may require different parameters and/or different values for the relevant parameters such as α and β. Upon generating the transformation matrix P, the counterfactual generation system 102 can utilize the transformation matrix P to project units into a lower-dimensional space and generate low-dimensional balanced nonlinear representation of each unit.

From the above equation, the counterfactual generation system 102 generates the transformation matrix P by determining the eigenvectors of matrix (K_{I}−αK_{W}−βKLK), which correspond to them leading eigenvalues. To illustrate, the Lagrangian function of the above object function for the BNR-NNM model 202 is:

[symbol]

=tr(P^{T}(αK_{W}−K_{I}+βKLK)P)−tr((P^{T}P−I)Z)

where Z is a Lagrangian multiplier.

By setting the derivative of the above Langrangian function [symbol] with respect to transformation matrix P to zero, the counterfactual generation system 102 can generate

$$\frac{\partial ℒ}{\partial P} = ( α {K}_{W} - {K}_{I} + β KLK ) P = PZ$$

which is an eigen-decomposition problem. Thus, as mentioned, the counterfactual generation system 102 can determine the solution of P as the eigenvectors of matrix (K_{I}−αK_{W}−βKLK) corresponding to the m leading eigenvalues.

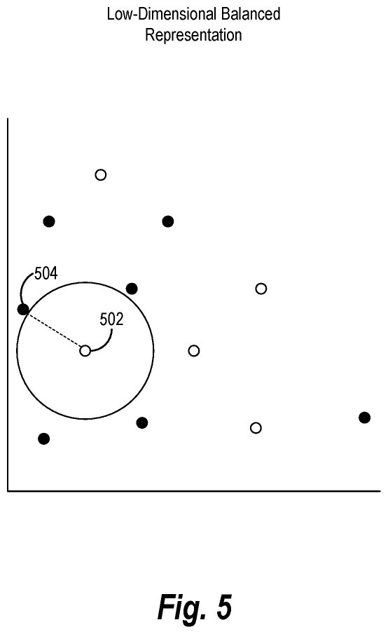

As mentioned, the counterfactual generation system 102 generates and utilizes a BNR-NNM model 202 based on generating a transformation matrix P as well as low-dimensional balanced nonlinear representation of units using the transformation matrix P. The counterfactual generation system 102 further utilizes the BNR-NNM model 202 to implement a matching model such as nearest neighbor matching (“NNM”) in relation to generated low-dimensional balanced nonlinear representations. Indeed, FIG. 5 illustrates a high-level depiction of identifying nearest neighbors by utilizing an NNM model such as the BNR-NNM model 202.

As shown, the counterfactual generation system 102 identifies, for a low-dimensional balanced nonlinear representation of a treated unit 502, a nearest neighbor control unit 504. For instance, the counterfactual generation system 102 identifies a low-dimensional balanced nonlinear representation of a control unit in low-dimensional space that is closest to or has the smallest distance from the low-dimensional balanced nonlinear representation of the treated unit. Indeed, as described, the counterfactual generation system 102 can generate low-dimensional balanced nonlinear representations for control and treated units as, respectively:

\hat{X}_{C}=P^{T}K_{C}

and

\hat{X}_{T}=P^{T}K_{T}

where K_{C} and K_{T} are the kernel matrices for the control and treatment groups, respectively.

In addition, the counterfactual generation system 102 can utilize a matching model such as a nearest neighbor matching model with respect to \hat{X}_{C} and \hat{X}_{T} to determine a distance between each treated unit and control unit within the low-dimensional space. The counterfactual generation system 102 can compare the distances of each low-dimensional balanced nonlinear representation of each control unit with respect to a given query treated unit (e.g., treated unit 502). Based on the comparison, the counterfactual generation system 102 can select a control unit 504 with a smallest distance from the treated unit in the new space.

Accordingly, the counterfactual generation system 102 determines that the outcome of the selected control unit serves and a predicted counterfactual. In particular, the counterfactual generation system 102 associates or ascribes an ordinal label of the treated unit 502 to the control unit 504 to fill in the missing data relating to the control unit 504. The counterfactual generation system 102 can thus generate predicted counterfactuals for each treated unit by identifying nearest control units and determining predicted ordinal labels.

Based on generating the predicted counterfactuals, the counterfactual generation system 102 can further determine an average effect. Indeed, the counterfactual generation system 102 can determine an average treatment effect on treated units based on the above-described

$$ATT A = \frac{1}{{N}_{T}} {\sum }_{k : {T}_{k} = 1} ( {Y}_{k} ( 1 ) - {\hat{Y}}_{k} ( 0 ) )$$

which is dependent on the transformation matrix P, as described above.

As mentioned, the counterfactual generation system 102 trains a nonlinear classification model (e.g., the BNR-NNM model 202) to generate predicted outcomes for units. In some embodiments, the counterfactual generation system 102 trains the nonlinear classification model 604 in RKHS. In this way, the counterfactual generation system 102 is more capable of dealing with complex data distributions than conventional systems that employ linear models. For example, treatment groups and control groups may have diverse distributions, and a nonlinear RKHS model can more effectively couple treated units and control units in a shared low-dimensional subspace. As another result of using an RKHS-based model, the counterfactual generation system 102 can produce closed-form solutions, which is beneficial for handling large-scale data (e.g., large sets of units and/or large numbers of covariates).

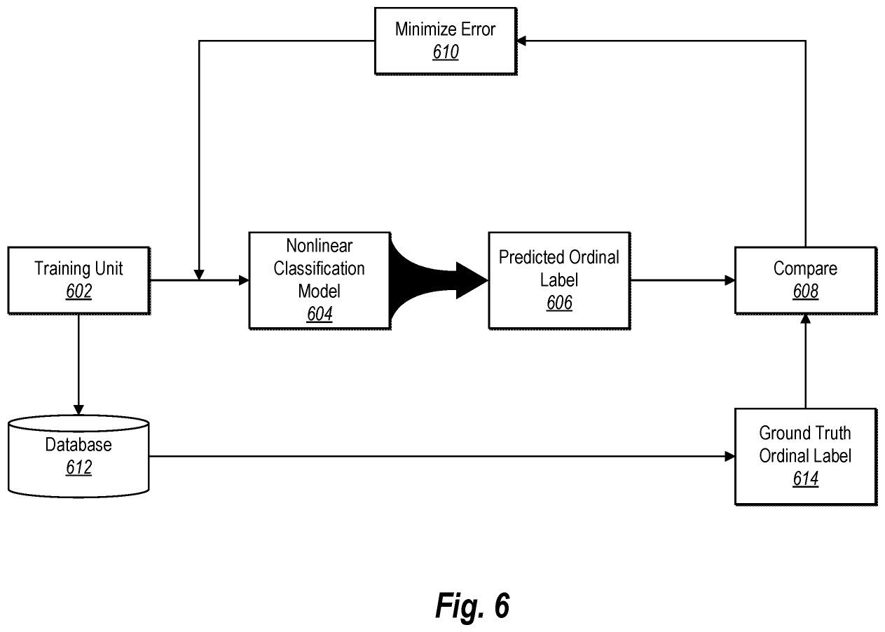

FIG. 6 illustrates training a nonlinear classification model 604 (e.g., the BNR-NNM model 202) utilizing training data. As shown, the counterfactual generation system 102 trains the nonlinear classification model 604 to generate predicted ordinal labels (which correspond to particular outcomes) based on input units. For example, the counterfactual generation system 102 accesses a database 612 to identify a training unit 602 and a ground truth ordinal label 614 that corresponds to the training unit 602. Indeed, the ground truth ordinal label 614 is an actual outcome or ordinal label class to which the training unit 602 belongs.

As illustrated in FIG. 6, the counterfactual generation system 102 inputs the training unit 602 into the nonlinear classification model 604. Based on the input of the training unit 602, the counterfactual generation system 102 utilizes the nonlinear classification model 604 to generate a predicted ordinal label 606 for the training unit 602. For instance, the counterfactual generation system 102 implements the nonlinear classification model 604 to classify or categorize the training unit 602 into a particular class of ordinal labels.

Additionally, the counterfactual generation system 102 can compare (608) the predicted ordinal label with the ground truth ordinal label 614. For example, the counterfactual generation system 102 can utilize a loss function to determine a measure of loss or error between the actual ground truth ordinal label 614 to which the training unit 602 belongs and the predicted ordinal label 616 generated by the nonlinear classification model 604. In some embodiments, the counterfactual generation system 102 can utilize a mean square error (“MSE”) function, a cross entropy loss function, a Kullback-Leibler loss function, or some other loss function.

Furthermore, the counterfactual generation system 102 can minimize the determined error or measure of loss (610). In particular, the counterfactual generation system 102 can modify parameters of the nonlinear classification model 604. For example, the counterfactual generation system 102 can adjust parameters including α, β, and c as well as (or alternatively to) various weights within layers of the nonlinear classification model 604. Indeed, the counterfactual generation system 102 can modify the parameters of the nonlinear classification model 604 to minimize or reduce the error—to more accurately generate a predicted ordinal label that more closely resembles the ground truth ordinal label 614.

Through the process described with reference to FIG. 6, the counterfactual generation system 102 trains or tunes the nonlinear classification model 604. Indeed, by repeatedly generating predicted ordinal labels for one or more training units, comparing the predicted ordinal labels with corresponding ground truth ordinal labels, and minimizing the error therebetween, the counterfactual generation system 102 can improve the accuracy of the nonlinear classification model 604. In some embodiments, the counterfactual generation system 102 can repeat the process described in relation to FIG. 6 until the counterfactual generation system 102 determines a measure of loss between the ground truth ordinal label 614 and a predicted ordinal label that is within a threshold measure of loss. Thus, the counterfactual generation system 102 can train or tune the nonlinear classification model 604 to accurately generate predicted ordinal labels.

In some embodiments, the counterfactual generation system 102 may not have access to ground truth ordinal labels which inhibits supervised learning for the nonlinear classification model 604. In these embodiments, the counterfactual generation system 102 can implement a randomized NNM estimator to implement multiple settings of a BNR-NNM model (e.g., BNR-NNM model 202) with different parameters α, β, and c. In addition, the counterfactual generation system 102 generates multiple ATT values for A and selects a value (e.g., the median value) as a final estimation of the average treatment effect on treated units. For example, the counterfactual generation system 102 can implement a randomized NNM estimator as set forth in Sheng Li, Nikos Vlassis, Jaya Kawale, and Yun Fu, Matching via Dimensionality Reduction for Estimation of Treatment Effects in Digital Marketing Campaigns, Proceedings of the Twenty-Fifth International Joint Conference on Artificial Intelligence, 3768-74 (2010), which is incorporated herein by reference in its entirety.

Additionally, or alternatively, the counterfactual generation system 102 can implement a model selection by cross-validation. In particular, the counterfactual generation system 102 can utilize a cross-validation technique to select proper values for α and β, by, for example, equally dividing the data and ordinal labels into k subsets. While these embodiments may increase computational cost to an extent, the counterfactual generation system 102 is still more efficient than conventional systems. Not only does the counterfactual generation system 102 reduce the dimensionality of covariates for units, but the counterfactual generation system 102 also generates a closed-form solution for the transformation matrix P, and the counterfactual generation system 102 further utilizes independent settings which enables parallel execution of the various methods and techniques of the counterfactual generation system 102.

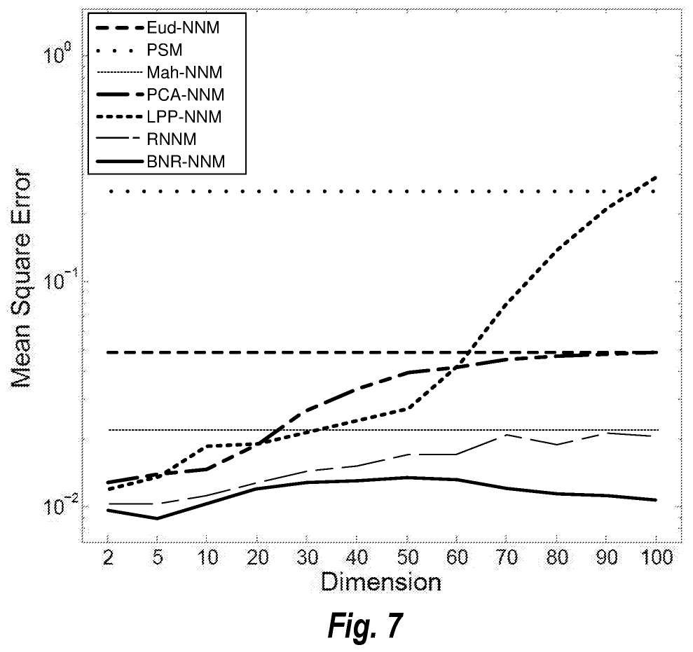

As mentioned, the counterfactual generation system 102 performs better than conventional systems. Indeed, FIG. 7 illustrates the accuracy improvement of the counterfactual generation system 102 as compared to several conventional state-of-the-art systems when tested with a synthetic dataset. As shown, the counterfactual generation system 102, by utilizing the BNR-NNM, has the lowest error of any of the conventional systems.

Testing the counterfactual generation system 102 with a synthetic dataset with a sample size N of 1000 and a number of covariates d of 100, the counterfactual generation system 102 produces a MSE less than the Euclidean distance-based NNM (“Eud-NNM”), the Mahalanobis distance-based NNM (“Mah-NNM”), the propensity score matching (“PSM”), principal component analysis-based NNM (“PCA-NNM”), locality preserving projections-based NNM (“LPP-NNM”), and randomized NNM (“RNNM”) at each dimensionality from 0 to 100. To perform the test using the synthetic dataset, the following basis functions are adopted for data generation:

g₁(x)=x−0.5,

g₂(x)=(x−0.5)²+2,

g₃(x)=x²−⅓

g₄(x)=−2 sin(2x),

g₅(x)=e^{-x}−e⁻¹−1,

g₆(x)=e^{-x},

g₇(x)=x²,

g₈(x)=x,

g₉(x)= [symbol] _{x>0}, and

g₁₀(x)=cos x

where, for each unit, the covariates x₁, x₂, . . . , x_{d} are drawn independently from the standard normal distribution [symbol] (0,1).

Considering binary treatment, the counterfactual generation system 102 utilizes a treatment vector T as T|x=1 if Σₖ₌₁⁵ gₖ(xₖ)>0 and T|x=0 otherwise. Given the covariate vector x and the treatment vector T, the outcome variables in Y are generated from the following model: Y|x,T˜ [symbol] (Σⱼ₌₁⁵ gⱼ₊₅(xⱼ)+T,1). The first five covariates are correlated to the treatments in T and the outcomes in Y, simulating a confounding effect, while the remaining covariates are noisy components. In addition, the true causal effect (i.e., the ground truth of ATT A) in the dataset of FIG. 7 is 1.

Furthermore, in relation to the MSE shown in FIG. 7, the counterfactual generation system 102 utilizes a BNR-NNM with α set to 1, β chosen from {10⁻³, 10⁻¹, 1, 10, 10³}. The number of categories c is chosen from {2, 4, 6, 8}. In addition, the experiment for the synthetic dataset uses a Gaussian kernel function

$$k ( {x}_{i} , {x}_{j} ) = exp ( \frac{- {‖ {x}_{i} - {x}_{j} ‖}^{2}}{2 {σ}^{2}} )$$

in which the bandwidth parameter σ is set to 5. In the experiment, the counterfactual generation system 102 allows for flexible setting of the various parameters, and the counterfactual generation system 102 enjoys greater accuracy (lower error) than conventional systems.

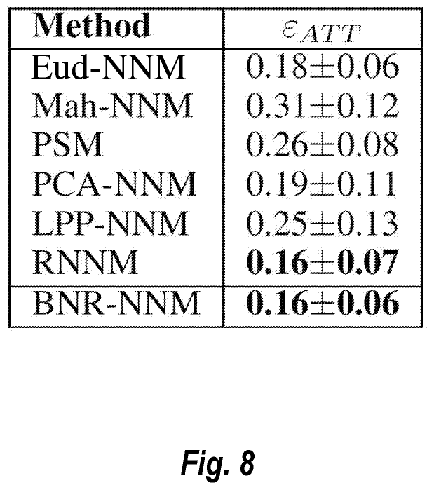

FIG. 8 illustrates results in relation to a particular test database, the dataset collected by the Infant Health and Development Program (“IHDP”). The table illustrates results of a measure of error of the counterfactual generation system 102 utilizing the BNR-NNM model as compared to the above-mentioned conventional systems. To collect the data, a randomized experiment was conducted where intensive high-quality care was provided to low-birth-weight and premature infants. By using original data and removing a nonrandom subset of the treatment group (all children with non-white mothers), the experiment utilized 24 pretreatment covariates (excluding race) and 747 units, including 608 control units and 139 treatment units. The outcomes are simulated by using the pretreatment covariates and the treatment assignment information in order to hold the unconfoundedness assumption.

Given the covariate matrix X and the treatment indicator vector T, the IHDP experiment of FIG. 8 uses the following simulation:

Y(0)=exp((X+W)β)+Z₀

where W is an offset matrix with every element equal to 0.5, β ∈ [symbol] ^{d×1} is a vector of regression coefficients (0, 0.1, 0.2, 0.3, 0.4) randomly sampled with probabilities (0.6, 0.1, 0.1, 0.1, 0.1), and Z₀ ∈ [symbol] ^{n×1} is a vector of elements randomly sampled from the standard normal distribution [symbol] (0,1);

Y(1)=X β−ω+Z₁

where β follows the same definition as described above, ω ∈ [symbol] ^{n×1} is a vector with every element to some constant that makes ATT equal to 4, Z₁ ∈ [symbol] ^{n×1} is also a vector of elements randomly drawn from the standard normal distribution [symbol] (0,1); and the factual outcome vector is defined as:

Y^{F}=Y(1)⊙T+T+Y(0)⊙(1−T)

and the counterfactual outcome vector is defined as:

Y^{CF}=Y(1)⊙(1−T)+T+Y(0)^{T}

where ⊙ represents the element-wise product. To produce extensive evaluations for the various systems, the experiment repeats the above procedures 200 times to generate 200 simulated outcomes, the results of which are reflected in FIG. 8. As shown, by implementing the BNR-NNM model, the counterfactual generation system 102 enjoys greater accuracy than the state-of-the art systems with regard to the IHDP dataset.

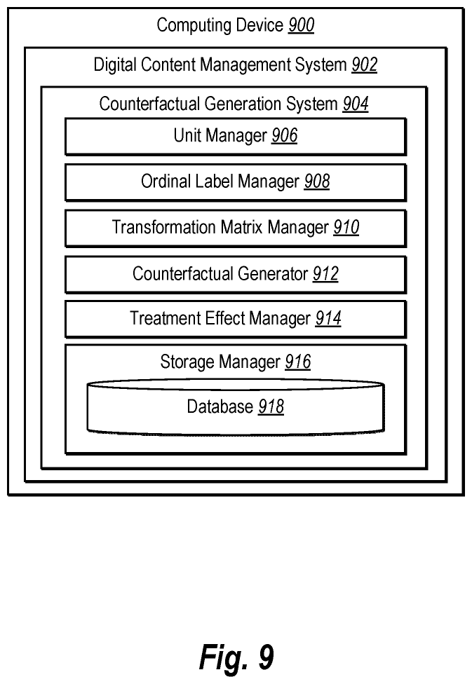

Looking now to FIG. 9, additional detail will be provided regarding components and capabilities of a counterfactual generation system 904 (e.g., an exemplary embodiment of the counterfactual generation system 102). Specifically, FIG. 9 illustrates an example schematic diagram of the counterfactual generation system 904 on an example computing device 900 (e.g., one or more of the publisher device 108, the client device 112, and/or the server(s) 104). As shown in FIG. 9, the counterfactual generation system 904 may include a unit manager 906, an ordinal label manager 908, a transformation matrix manager 910, a counterfactual generator 912, a treatment effect manager 914, and a storage manager 916.

As mentioned, the counterfactual generation system 904 can include a unit manager 906. In particular, the unit manager 906 can manage, maintain, identify, determine, collect, gather, or generate units. For example, the unit manager 906 can identify units such as users of client devices. In addition, the unit manager 906 can identify or generate various groups within a set of units such as a control group and a treatment group. For instance, the unit manager 906 can determine which units are treated (e.g., exposed to a particular treatment such as an item of digital content) and which are not and can group the units accordingly.

As shown, the counterfactual generation system 904 further includes an ordinal label manager 908. In particular, the ordinance label manager 908 can analyze a set of outcomes associated with units to categorize or separate the outcomes into a set of ordinal labels. Indeed, the ordinal label manager 908 can implement a clustering technique or a kernel density estimation technique to discretize an outcome vector and generate ordinal labels in accordance with this disclosure.

Additionally, the counterfactual generation system 904 includes a transformation matrix manager 910. In particular, the transformation matrix manager 910 can learn, generate, determine, or produce a transformation matrix. For example, the transformation matrix manager 910 can generate low-dimensional nonlinear representations of units by utilizing an ordinal scatter discrepancy model. The transformation matrix manager 910 can further generate low-dimensional balanced nonlinear representations of units utilizing a maximum mean discrepancy model. Based on determining low-dimensional balanced nonlinear representations, the transformation matrix manager 910 can generate a transformation matrix P in accordance with this disclosure.

In addition, the counterfactual generation system 904 includes a counterfactual generator 912. In particular, the counterfactual generator 912 can communicate with the transformation matrix manager 910 to utilize a transformation matrix to transform units into low-dimensional balanced nonlinear representations and to further generate counterfactuals for the units in low-dimensional space. Indeed, the counterfactual generator 912 can implement a matching model to match low-dimensional balanced nonlinear representations of treated units with nearby (in low-dimensional space) low-dimensional balanced nonlinear representations of control units. In addition, the counterfactual generator 912 can further communicate with the ordinal label manager 908 to generate predicted ordinal labels for the low-dimensional balanced nonlinear representations of units. Thus, the counterfactual generator 912 can supplement missing data for control units by generating counterfactuals for the treated units in accordance with this disclosure.

As illustrated, the counterfactual generation system 904 further includes a treatment effect manager 914. In particular, the treatment effect manager 914 can communicate with the counterfactual generator 912 to determine or generate an average treatment effect for a set of units. Indeed, the treatment effect manager can determine an ATT by utilizing an average treatment effect algorithm in accordance with the above description.

Furthermore, the counterfactual generation system 904 can include a storage manager 916. In particular, the storage manager 916 can manage or maintain a database 918 that includes information such as unit data, factual data, counterfactual data, outcome data, ordinal label data, or other data necessary for the counterfactual generation system 904 to perform the methods and techniques of this disclosure. To illustrate from the description of FIG. 6, the storage manager 916 can manage a database that includes training units and ground truth ordinal labels for training a nonlinear classification model.

As illustrated, the counterfactual generation system 904 and its components can be included in a digital content management system 902 (e.g., the digital content management system 106). In particular, the digital content management system 902 can include a digital content editing system, a digital content campaign system, or a digital media distribution system.

In one or more embodiments, each of the components of the counterfactual generation system 904 are in communication with one another using any suitable communication technologies. Additionally, the components of the counterfactual generation system 904 can be in communication with one or more other devices including one or more user client devices described above. It will be recognized that although the components of the counterfactual generation system 904 are shown to be separate in FIG. 9, any of the subcomponents may be combined into fewer components, such as into a single component, or divided into more components as may serve a particular implementation. Furthermore, although the components of FIG. 9 are described in connection with the counterfactual generation system 904, at least some of the components for performing operations in conjunction with the counterfactual generation system 904 described herein may be implemented on other devices within the environment.

The components of the counterfactual generation system 904 can include software, hardware, or both. For example, the components of the counterfactual generation system 904 can include one or more instructions stored on a computer-readable storage medium and executable by processors of one or more computing devices (e.g., the computing device 900). When executed by the one or more processors, the computer-executable instructions of the counterfactual generation system 904 can cause the computing device 900 to perform the methods described herein. Alternatively, the components of the counterfactual generation system 904 can comprise hardware, such as a special purpose processing device to perform a certain function or group of functions. Additionally or alternatively, the components of the counterfactual generation system 904 can include a combination of computer-executable instructions and hardware.

Furthermore, the components of the counterfactual generation system 904 performing the functions described herein may, for example, be implemented as part of a stand-alone application, as a module of an application, as a plug-in for applications including content management applications, as a library function or functions that may be called by other applications, and/or as a cloud-computing model. Thus, the components of the counterfactual generation system 904 may be implemented as part of a stand-alone application on a personal computing device or a mobile device. Alternatively or additionally, the components of the counterfactual generation system 904 may be implemented in any application that allows creation and delivery of marketing content to users, including, but not limited to, applications in ADOBE CREATIVE CLOUD and/or ADOBE MARKETING CLOUD, such as ADOBE CAMPAIGN, ADOBE ANALYTICS, and ADOBE MEDIA OPTIMIZER. “ADOBE,” “CREATIVE CLOUD,” “MARKETING CLOUD,” “CAMPAIGN,” “ANALYTICS,” and “MEDIA OPTIMIZER,” are registered trademarks of Adobe Systems Incorporated in the United States and/or other countries.

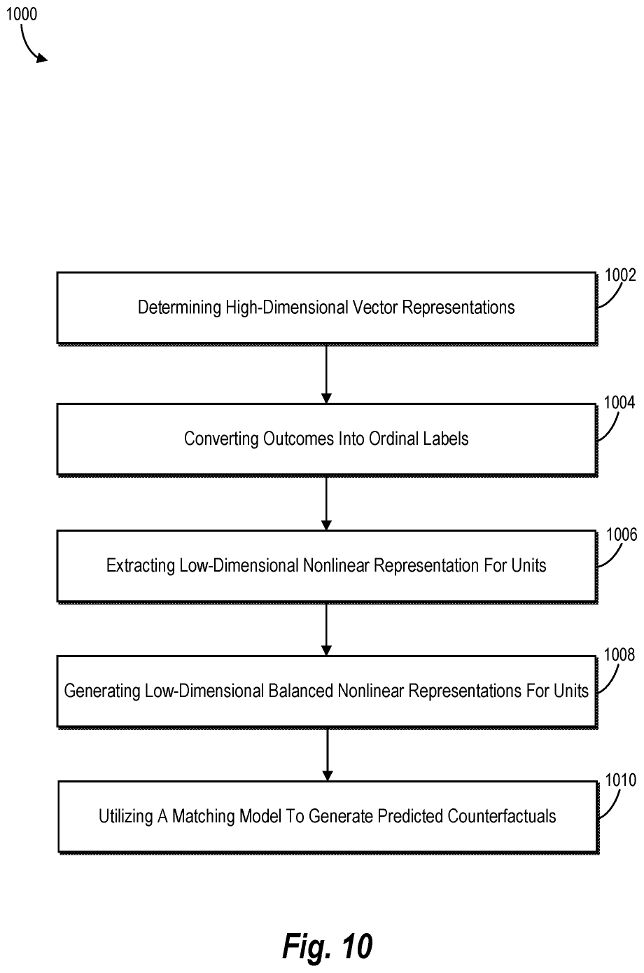

FIGS. 1-9, the corresponding text, and the examples provide a number of different systems, methods, and non-transitory computer readable media for generating and providing an average treatment effect based on counterfactuals. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 of generating counterfactuals for determining an average treatment effect. The series of acts 1000 includes an act 1002 of determining high-dimensional vector representations. In particular, the act 1002 can include determining, for a plurality of units, high-dimensional vector representations that include covariates associated with the plurality of units. The plurality of units can include a control group including control units and a treatment group including treated units.

As shown, the series of acts 1000 further includes an act 1004 of converting outcomes into ordinal labels. In particular, the act 1004 can include converting a plurality of outcomes associated with the plurality of units into a set of ordinal labels. For example, the act 1004 can involve utilizing one or more of a clustering technique or a kernel density estimation technique to discretize the plurality of possible outcomes.

The series of acts 1000 also includes an act 1006 of extracting low-dimensional nonlinear representations for units. In particular, the act 1006 can include extracting, by utilizing an ordinal scatter discrepancy model based on the set of ordinal labels, low-dimensional nonlinear representations for the plurality of units. For example, the act 1006 can involve constructing a kernel matrix based on a noncontiguous-class scatter matrix and a within-class scatter matrix.

As shown, the series of acts 1000 further includes an act 1008 of generating low-dimensional balanced nonlinear representations for units. In particular, the act 1008 can include generating, by utilizing a maximum mean discrepancy model and based on the extracted low-dimensional nonlinear representations, low-dimensional balanced nonlinear representations for the plurality of units.

The series of acts 1000 can further include an act 1010 of utilizing a matching model to generate predicted counterfactuals. In particular, the act 1010 can include utilizing a matching model in relation to the low-dimensional balanced nonlinear representations to generate predicted counterfactuals for the plurality of units. For example, the act 1010 can involve utilizing a nearest neighbor matching model, a weighting model, or a subclassification model. The act 1010 can further involve utilizing a trained nonlinear classification model. In some embodiments, the act 1010 can involve utilizing, for a treated unit from among the treated units, a matching model in relation to a low-dimensional balanced nonlinear representation of the treated unit to generate a predicted counterfactual for a control unit with a smallest distance in low-dimensional space from the treated unit.

The series of acts 1000 can include acts of identifying a treated unit from the treatment group, determining, for the identified treated unit, a distance in a low-dimensional space between the treated unit and one or more control units from the control group, and selecting a control unit from the one or more control units with a smallest distance from the identified treated unit. In addition, the series of acts 1000 can include an act of generating a predicted counterfactual by generating a predicted ordinal label corresponding to the selected control unit. The series of acts 1000 can further include an act of generating an average treatment effect on treated units based on the predicted ordinal label. Generating the average treatment effect on treated units can include implementing an average treatment effect algorithm. Additionally, the series of acts can include an act of training the nonlinear classification model to generate predicted counterfactuals.

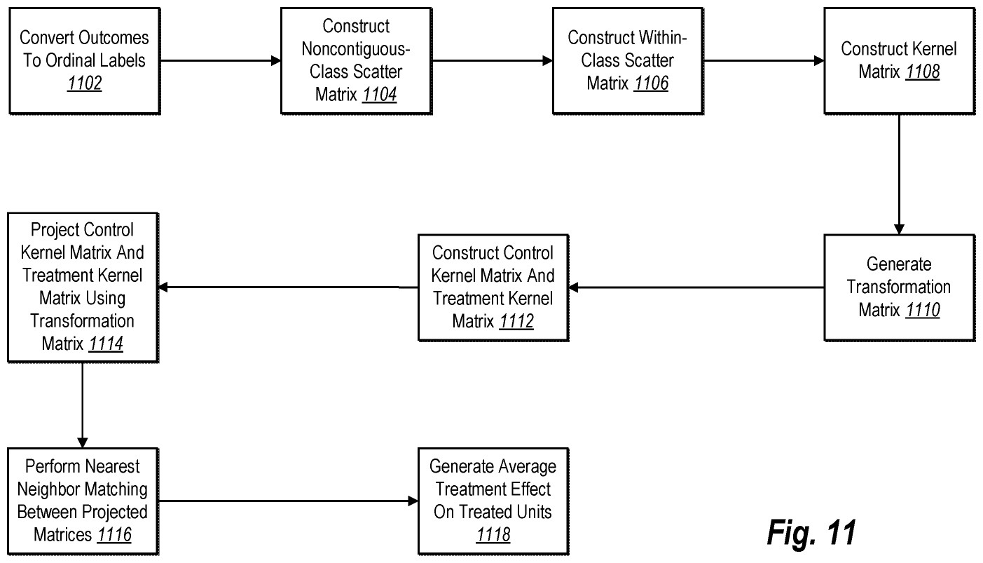

As mentioned, the counterfactual generation system 102 can generate counterfactuals and an ATT for a given causal inference problem. Indeed, FIG. 11 illustrates exemplary acts in a step for determining an average treatment effect on treated units. As illustrated, the step for determining an average treatment effect on treated units can include acts 1102-1118.

In particular, the counterfactual generation system 102 can perform an act 1102 to convert outcomes to ordinal labels. As described, the counterfactual generation system 102 can utilize a clustering technique or a kernel density estimation technique to discretize an outcome vector and generate a set of ordinal labels. Thus, the counterfactual generation system 102 can generate a set of classes or categorize—the ordinal labels—from possible outcomes associated with the units.

In addition, the counterfactual generation system 102 can perform an act 1104 to construct a noncontiguous-class scatter matrix. As described above in relation to FIG. 3, the counterfactual generation system 102 can generate a noncontiguous-class scatter matrix K_{I}^{Φ}. Indeed, the counterfactual generation system 102 can generate the noncontiguous-class scatter matrix in kernel space to characterize the scatter of a set of classes with ordinal labels and measure the scatter of every pair of classes.

The counterfactual generation system 102 can further perform an act 1106 to construct a within-class scatter matrix. As described above in relation to FIG. 3, the counterfactual generation system 102 can generate a within-class scatter matrix K_{W}^{Φ}. In particular, the counterfactual generation system 102 generates the within-class scatter matrix to measure within-class scatter, where units having the same ordinal labels are closer together in the feature space, and therefore have similar feature representations after projection.

Additionally, the counterfactual generation system 102 can perform an act 1108 to construct a kernel matrix. For example, the counterfactual generation system 102 can generate the kernel matrix K, as described above with reference to FIG. 4.

Furthermore, the counterfactual generation system 102 can perform an act 1110 to generate a transformation matrix. As described above, the counterfactual generation system 102 can generate the transformation matrix P based on the kernel matrix. Indeed, the counterfactual generation system 102 can generate the transformation matrix P based on the eigenvectors of the matrix (K_{I}−αK_{W}−βKLK), which correspond to the m leading eigenvalues.

The counterfactual generation system 102 can still further perform an act 1112 to construct a control kernel matrix and a treatment kernel matrix. As described above in relation to FIG. 5, the counterfactual generation system 102 can generate a control kernel matrix K_{C} and a treatment kernel matrix K_{T}.

As shown, the counterfactual generation system 102 can also perform an act 1114 to project the control kernel matrix and the treatment kernel matrix using the transformation matrix. In particular, the counterfactual generation system 102 can project the control kernel matrix K_{C} and the treatment kernel matrix K_{T} using the transformation matrix P, as described above. Thus, the counterfactual generation system 102 can generate low-dimensional balanced nonlinear representations of units in a new space.

As further illustrated, the counterfactual generation system 102 can perform an act 1116 to perform nearest neighbor matching between projected matrices. As described above, the counterfactual generation system 102 can utilize a nearest neighbor matching model to determine control units that are nearest to treated units within the low-dimensional space. For example, the counterfactual generation system 102 can determine a distance between each treated unit and control unit and can select, for each treated unit, a control unit with the smallest distance away from the given treated unit.

Further, the counterfactual generation system 102 can perform an act 1118 to generate an average treatment effect on treated units (ATT). As described above, the counterfactual generation system 102 can utilize an average treatment effect on treated algorithm to determine an ATT A for a set of units.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an example computing device 1200 (e.g., computing device 900, publisher device 108, client device 112, and/or server(s) 104) that may be configured to perform one or more of the processes described above. One will appreciate that the counterfactual generation system 102 can comprise implementations of the computing device 1200. As shown by FIG. 12, the computing device can comprise a processor 1202, memory 1204, a storage device 1206, an I/O interface 1208, and a communication interface 1210. Furthermore, the computing device 1200 can include an input device such as a touchscreen, mouse, keyboard, etc. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1404 may be internal or distributed memory.

The computing device 1200 includes a storage device 1206 includes storage for storing data or instructions. As an example, and not by way of limitation, storage device 1206 can comprise a non-transitory storage medium described above. The storage device 1206 may include a hard disk drive (HDD), flash memory, a Universal Serial Bus (USB) drive or a combination of these or other storage devices.

The computing device 1200 also includes one or more input or output (“I/O”) devices/interfaces 1208, which are provided to allow a user to provide input to (such as user strokes), receive output from, and otherwise transfer data to and from the computing device 1200. These I/O devices/interfaces 1208 may include a mouse, keypad or a keyboard, a touch screen, camera, optical scanner, network interface, modem, other known I/O devices or a combination of such I/O devices/interfaces 1208. The touch screen may be activated with a writing device or a finger.

The I/O devices/interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1208 is configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 can provide one or more interfaces for communication (such as, for example, packet-based communication) between the computing device and one or more other computing devices 1200 or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. In a digital medium environment for evaluating performance of digital content campaigns, a computer-implemented method for determining an average treatment effect by predicting counterfactuals using a machine learning algorithm, the computer-implemented method comprising:
determining, for a plurality of units, high-dimensional vector representations that include covariates associated with the plurality of units;
converting a plurality of outcomes associated with the plurality of units into a set of ordinal labels; and
a step for determining an average treatment effect on treated units.

2. The method of claim 1, wherein converting the plurality of possible outcomes into the set of ordinal labels comprises utilizing one or more of a clustering technique or a kernel density estimation technique to discretize the plurality of possible outcomes.

3. The method of claim 1, further comprising training a nonlinear classification model to generate predicted counterfactuals.

4. The method of claim 1, wherein the plurality of units comprises a control group comprising control units and a treatment group comprising treated units.

5. A non-transitory computer readable medium comprising instructions that, when executed by at least one processor, cause a computing device to:
determine, for a plurality of units, high-dimensional vector representations that include covariates associated with the plurality of units;
convert a plurality of outcomes associated with the plurality of units into a set of ordinal labels;
extract, by utilizing an ordinal scatter discrepancy model based on the set of ordinal labels, low-dimensional nonlinear representations for the plurality of units;
generate, by utilizing a maximum mean discrepancy model and based on the extracted low-dimensional nonlinear representations, low-dimensional balanced nonlinear representations for the plurality of units; and
utilize a matching model in relation to the low-dimensional balanced nonlinear representations to generate predicted counterfactuals for the plurality of units.

6. The non-transitory computer readable medium of claim 5, wherein the plurality of units comprises a control group comprising control units and a treatment group comprising treated units.

7. The non-transitory computer readable medium of claim 6, wherein the instructions cause the computing device to convert the plurality of outcomes into the set of ordinal labels by utilizing one or more of a clustering technique or a kernel density estimation technique to discretize the plurality of possible outcomes.

8. The non-transitory computer readable medium of claim 7, further comprising instructions that, when executed by the at least one processor, cause the computing device to:
identify a treated unit from the treatment group;
determine, for the identified treated unit, a distance in a low-dimensional space between the treated unit and one or more control units from the control group; and
select a control unit from the one or more control units with a smallest distance from the identified treated unit.

9. The non-transitory computer readable medium of claim 8, further comprising instructions that, when executed by the at least one processor, cause the computing device to generate a predicted counterfactual by generating a predicted ordinal label corresponding to the selected control unit.

10. The non-transitory computer readable medium of claim 9, further comprising instructions that, when executed by the at least one processor, cause the computing device to generate an average treatment effect on treated units based on the predicted ordinal label.

11. The non-transitory computer readable medium of claim 10, wherein the instructions cause the computing device to generate the average treatment effect on the identified treated unit by implementing an average treatment effect algorithm.

12. The non-transitory computer readable medium of claim 5, wherein the matching model comprises a nearest neighbor matching model.

13. The non-transitory computer readable medium of claim 5, wherein the instructions cause the computing device to generate low-dimensional balanced nonlinear representations for the plurality of units by constructing a kernel matrix based on a noncontiguous-class scatter matrix and a within-class scatter matrix.

14. The non-transitory computer readable medium of claim 5, wherein the instructions cause the computing device to generate the predicted counterfactuals by utilizing a trained nonlinear classification model.

15. The non-transitory computer readable medium of claim 14, further comprising instructions that, when executed by the at least one processor, cause the computing device to train the nonlinear classification model to generate predicted counterfactuals.

16. A system comprising:
at least one processor; and
a non-transitory computer readable medium comprising a balanced nonlinear representation nearest neighbor matching model and instructions that, when executed by the at least one processor, cause the system to:
determine, for a plurality of units comprising control units and treated units, high-dimensional vector representations that include covariates associated with the plurality of units;
convert a plurality of outcomes associated with the plurality of units into a set of ordinal labels;
extract, by utilizing an ordinal scatter discrepancy model based on the set ordinal labels, low-dimensional nonlinear representations for the plurality of units;
generate, by utilizing a maximum mean discrepancy model and based on the extracted low-dimensional nonlinear representations, low-dimensional balanced nonlinear representations for the plurality of units;
utilize, for a treated unit from among the treated units, a matching model in relation to a low-dimensional balanced nonlinear representation of the treated unit to generate a predicted counterfactual for a control unit with a smallest distance in low-dimensional space from the treated unit; and
generate, based on the predicted counterfactual, an average treatment effect for the treated units.

17. The system of claim 16, further comprising instructions that, when executed by the at least one processor, cause the system to determine a distance between the treated unit and one or more of the control units.

18. The system of claim 16, wherein the instructions cause the system to generate low-dimensional balanced nonlinear representations for the plurality of units by constructing a kernel matrix based on a noncontiguous-class scatter matrix and a within-class scatter matrix.

19. The system of claim 16, wherein the matching model comprises one or more of a nearest neighbor matching model, a weighting model, or a subclassification model.

20. The system of claim 16, further comprising instructions that, when executed by the at least one processor, cause the system to train a nonlinear classification model to generate predicted counterfactuals.
